(19) United States
(12) Patent Application Publication
(10) Pub. No.: US 2026/0307867 A1
(43) Pub. Date: Oct. 8, 2026

(54) LID FOR BEVERAGE CONTAINER

(71) Applicant: KAZ EUROPE SÀRL, Bussigny (CH)

(72) Inventors: Dzmitry Varhan, Dingmans Ferry, PA (US); Martin Mutch, Bend, OR (US); Samuel Wilson Moody Fear, Mattituck, NY (US)

(21) Appl. No.: 19/481,250

(22) PCT Filed: May 21, 2024
(86) PCT No.: PCT/US2024/030311

§ 371 Date: Nov. 4, 2025

Related U.S. Application Data
(60) Provisional application No. 63/468,348, filed on May 23, 2023.

(51) Int. Cl. B65D 47/30; A47G 19/22; B65D 51/24

(52) U.S. Cl. CPC B65D 47/30; A47G 19/2272; B65D 51/242

(57) ABSTRACT

A lid for a beverage container includes a lid body and a drink opening. A lever is connected to and above the lid body and movable between a closed position for covering the drink opening and an open position. A lever member is connected to and beneath the lid body and movable between a sealed position for sealingly closing the drink opening and an unsealed position for opening the drink opening. A container seal is provided within the lid body for sealingly engaging the container. The container seal includes a biasing element in contact with the lever member. The biasing element is configured to maintain the lever member in the sealed position and is configured to move the lever member from the unsealed position back toward the sealed position with respect to the drinking opening.

### BACKGROUND

Beverage containers, in particular so-called “travel mugs” or “tumblers” or “flasks” are very popular. These beverage containers normally comprise a vessel and lid complimentary to the vessel to help maintain the temperature of the beverage within the vessel and also reduce the likelihood of spills of the beverage from the vessel during use. Many such container lids include a drink opening that can be selectively opened and closed. While such beverage containers and lids according to the prior art provide a number of advantages, they nevertheless have certain limitations, including the tendency of the lid to maintain an open position while not in use.

### BRIEF DESCRIPTION

According to one aspect, a lid for a beverage container comprises a lid body and a drink opening. A lever is connected to and above the lid body and movable between a closed position for covering the drink opening and an open position. A lever member is connected to and beneath the lid body and movable between a sealed position for sealingly closing the drink opening and an unsealed position for opening the drink opening. A container seal is provided within the lid body for sealingly engaging the container. The container seal includes a biasing element in contact with the lever member. The biasing element is configured to maintain the lever member in the sealed position and is configured to move the lever member from the unsealed position back toward the sealed position with respect to the drinking opening.

### BRIEF DESCRIPTION OF THE DRAWINGS

FIG. 1 is a perspective view of a lid for an associated beverage container according to one aspect of the present disclosure.

FIG. 2 is a bottom perspective view of FIG. 1.

FIG. 3 is a partial exploded perspective view of FIG. 1.

FIGS. 4 and 5 are respective top and bottom perspective views of an inner body of a lid body of the exemplary lid of FIG. 1.

FIGS. 6 and 7 are perspectives views of a lever member of the exemplary lid of FIG. 1.

FIGS. 8 and 9 are perspectives views of a container seal or gasket of the exemplary lid of FIG. 1.

FIG. 10 is a cross-sectional view of the exemplary lid of FIG. 1 with the lever in a closed position and the lever member in a sealed position.

FIGS. 11 and 12 are cross-sectional views of the exemplary lid of FIG. 1 showing the lever being moved to an open position and the lever member being moved to an unsealed position.

FIG. 13 is a cross-sectional view of the exemplary lid of FIG. 1 with the lever in the open position and the lever member in the unsealed position.

FIG. 14 is a perspective view of a lid for an associated beverage container according to another aspect of the present disclosure.

FIG. 15 is a partial exploded perspective view of FIG. 14.

FIG. 16 is a cross-sectional view of the exemplary lid of FIG. 14 with a lever in a closed position and a lever member in a sealed position.

FIGS. 17 and 18 are cross-sectional views of the exemplary lid of FIG. 14 showing the lever being moved to an open position and the lever member being moved to an unsealed position.

FIG. 19 is a cross-sectional view of the exemplary lid of FIG. 14 with the lever in the open position and the lever member in the unsealed position.

### DETAILED DESCRIPTION

It should, of course, be understood that the description and drawings herein are merely illustrative and that various modifications and changes can be made in the structures disclosed without departing from the present disclosure. For purposes of description herein, spatially relative terms may be used to describe an element and/or feature's relationship to another element(s) and/or feature(s) as, for example, illustrated in the figures of the present disclosure. Further, any term of degree used herein, such as “substantially”, means a reasonable amount of deviation of the modified word is contemplated such that the end result is not significantly changed.

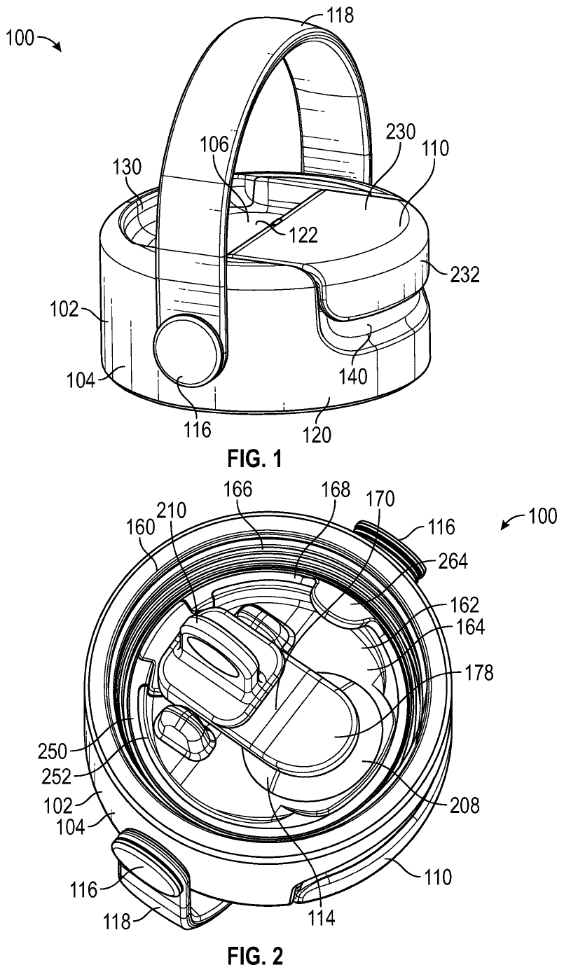

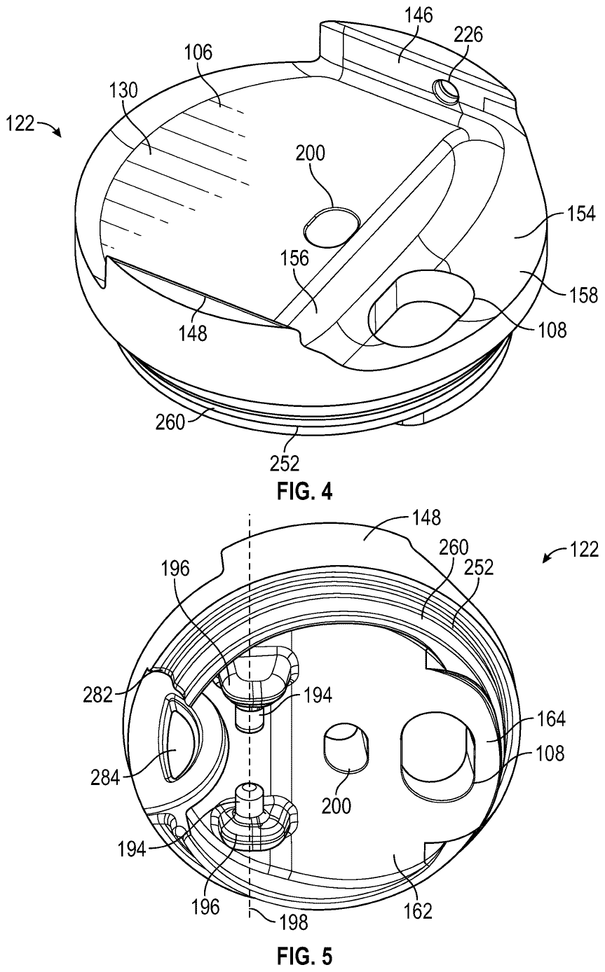

Referring now to the drawings, wherein like numerals refer to like parts throughout the several views, FIGS. 1-3 illustrates an exemplary lid 100 according to one aspect the present disclosure which is complementary to an associated beverage or fluid container (not shown). The associated container may correspond to or resemble a bottle, jug, growler, vessel, carafe, or similar beverage container. The lid 100 (which may alternatively be referred to as a closure or cap) includes a lid body 102 having a sidewall 104 and a top wall 106. The lid body 102 is shown as being substantially cylindrical shaped; although, alternative shapes are contemplated depending on connection to the associated beverage container. The top wall 106 is provided with a drinking opening 108 (FIGS. 4 and 5) through which liquid may flow. A lever or flip 110 is connected to the lid body 102 and is movable between a closed position and an open position, specifically rotatable about a rotational axis 112 defined by the connection of the lever 110 with the lid body 102, relative to the lid body to selectively seal and unseal a lever sealing member 114 to close and open, respectively, the drinking opening 108. Strap connectors or lugs 116 extend outwardly from the sidewall 104 to allow a strap 118 to connect with the lid 100.

The lid body 102 can be defined by an outer body 120 and an inner body 122. The outer body 120 and the inner body 122 can be fixedly secured so as to define a unitary, one-piece component of the lid 100. By way of example, the outer body 120 can be integrally formed with the inner body 122 via a two-component injection molding. The outer body 120 has the sidewall 104, and the inner body 122 has the top wall 106, and at least one of the outer body 120 and the inner body 122 is connected to the lever 110. The outer body 120 and the inner body 122 define an elongated recessed portion 130 for the lever 110 that extends between a forward end 132 adjacent the drinking opening 108 and a rearward end 134 along the top wall 106, such that the recessed portion 130 extends in a direction perpendicular to the rotational axis 112 of the lever 110.

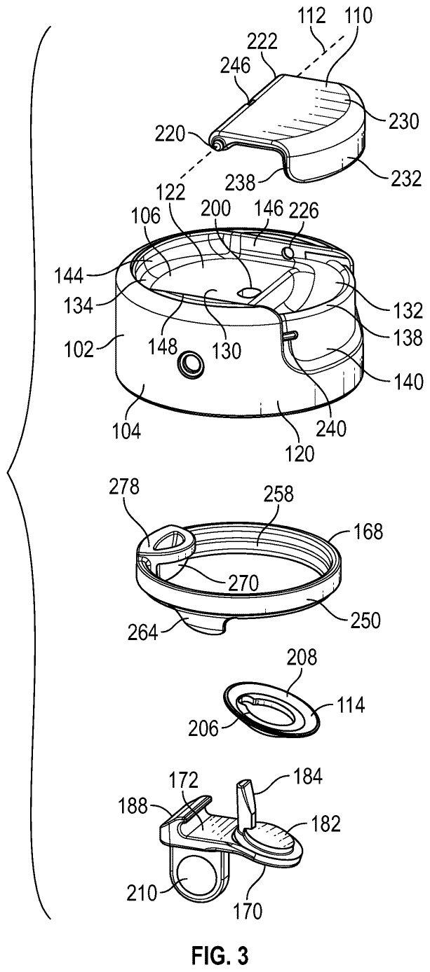

The recessed portion 130 terminates at a drinking lip 138 at the forward end, which is formed by an offset section 140 in the sidewall 104. In the depicted aspect and with reference to FIG. 3, the recessed portion 130 includes an end wall 144 defined by the outer body 120 and sidewalls 146, 148 projecting upwardly from the top wall 106 and defined by the inner body 122. In FIG. 4, the top wall 106 of the lid body 102 has a drinking surface 154 extending around the drinking opening 108. The drinking surface 154 offset downwardly from a remainder of the top wall by a ledge 156 and is swooped or inclined upward from the ledge 156 to an elevated portion 158 at the drinking lip 138. The sidewall 104 forms a downwardly opening open-ended cavity 160. In FIG. 5, a bottom wall 162 opposite the top wall 106 of the inner body 122 located within the cavity 160 has a sealing surface 164 extended around the perimeter of the drinking opening 108. The bottom wall having the sealing surface can be inclined downwardly toward the forward end 132 to allow for a smooth flow of liquid through the drinking opening 108.

The lid 100 is transitionable between an attached, sealed state and a detached state with respect to the associated container. To this end, the lid 100 may include one or more suitable structures and components configured so as to provide a sealing arrangement for the container. By way of example, with the substantially cylindrical shaped lid body 102, the sidewall 104 may include a securing element (i.e., a threading 166) that is complementary to a securing element disposed on the associated container. It should be appreciated that additional and/or alternative configurations of securing elements may be used to secure the lid 100 against the associated container in a fluid-tight configuration, such as a bayonet mount, a friction fit, a snap-fit or crimped rim. A container seal or gasket 168 is secured within the cavity 160 and is sized to aid in sealing the lid 100 to the associated container.

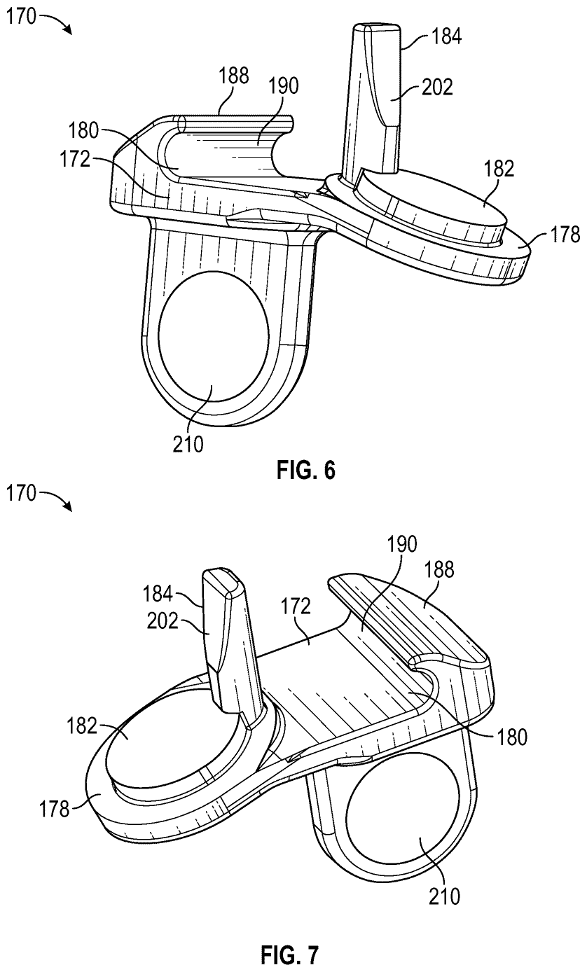

A lever member 170 is connected to the bottom wall 162 of the inner body 122 of the lid body 102 (FIG. 2). The lever sealing member 114 is mounted to the lever member 170, and the lever member 170 is movable relative to the bottom wall 162 by movement of the lever 110. This movement of the lever member 170 selectively seals and unseals the lever sealing member 114 to close and open, respectively, the drinking opening 108. Referring to FIGS. 6 and 7, the lever member 170 has a body 172 with a first end portion 178 and a second end portion 180 opposite the first end portion relative to a length direction of the body 172. The first end portion is inclined downward to correspond to the inclination of the sealing surface 164 so that the sealing member 114 can properly seal around the drink opening 108. A platform 182 is provided on the first end portion 178 and a piston or post 184 is located on the body 172 adjacent the platform 182. An attachment element 188 is located at the second end portion 180. In the depicted aspect, a slot 190 is provided on the attachment element 188 for receiving pivot pins 194 providing on mounting tabs 196 depending from the bottom wall 162 (FIG. 5) of the lid body 102. The slot 190 is sized and shaped to removably receive and securely rotatably retain the pivot pins 194 therein in a snap-fit relationship allowing the lever member 170 to rotate about a rotational axis 198 defined by the pins 194 between sealed and unsealed positions with respect to the drinking opening 108 when a rotational force is applied to the lever member 170 by a user rotating the lever 110. In the present aspect, the rotational axis 198 extends parallel to the rotational axis 112 of the lever 110. It should be appreciated that other manners to provide rotational attachment of the lever member 170 to the lid body 102 are contemplated.

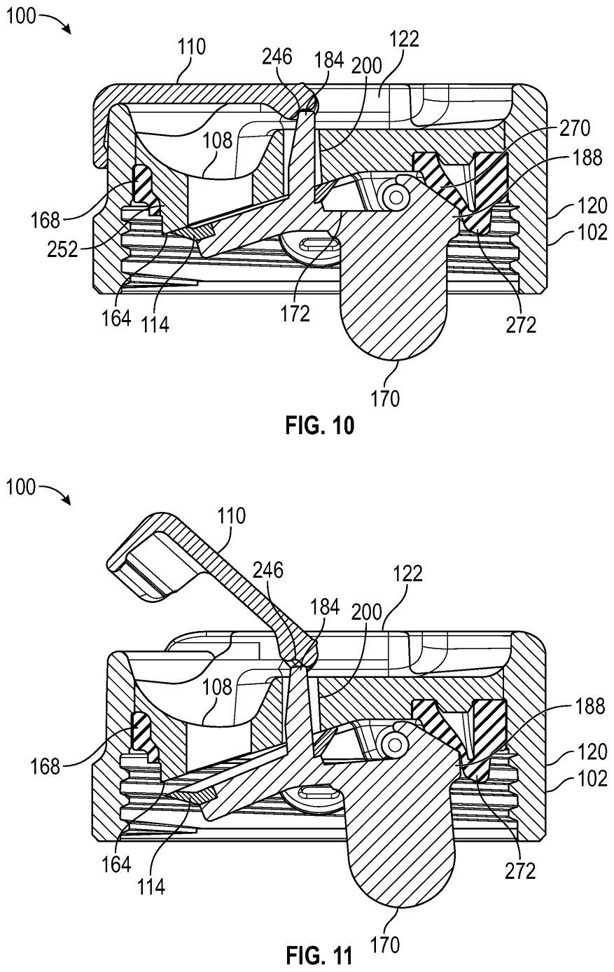

With the lever member 170 connected to the bottom wall 162 of the lid body 102, the post 184 projects through an opening 200 (FIGS. 5 and 6) in the inner body 122 for engagement with the lever 110. In FIG. 10, an end portion of the post 184 extends outwardly from the top wall 106 of the lid body 102 in the sealed position of the lever member 170. The opening 200 is sized to allow the post 184 to move or pivot therein as the lever member 170 is moved between the sealed and unsealed positions. The post 184 can include a substantially planar face 202 which severs as a rotational stop for the lever member 170. As shown in FIG. 3, the lever sealing member 114 includes an opening 206 shaped to receive both the platform 182 and the post 184. When properly mounted on the first end portion 178, a seal lip 208 of the lever sealing member 114 extends around the platform 182 and the post 184. The seal lip 208 forms a fluid-tight seal with the sealing surface 164 of the bottom wall 162 of the lid body 102 which extends around the perimeter of the drinking opening 108 and the perimeter of the post opening 200 when the lever member 170 is in a sealed position (FIG. 2). The lever member 170 can further include a removal tab 210 depending from the body 172 to allow for easy disconnection of the lever member from the lid body 102.

With reference to FIGS. 1 and 3, the lever 110 is connected to the lid body 102 via two pivot pins 220 extended laterally outward from an edge portion 222 of the lever. The pivot pins 220 are rotatably received in apertures 226 in the sidewalls 146, 148 that define the recessed portion 130. It should be appreciated that other manners to provide rotational attachment of the lever 110 to the lid body 102 are contemplated. The lever 110 includes an upper surface 230 and a side surface 232. In the closed position of the lever 110, the upper surface 230 covers the forward end 132 of the recessed portion 130 including the drinking opening 108 and the side surface 232 is provided over the drinking lip 138 and is received in the offset section 140 of the sidewall 104. Further, in the closed position, the side surface 232 is substantially a continuation of the sidewall 104 to substantially maintain a constant diameter of the lid body along a height dimension of the lid body. An inner lip 238 on the side surface 232 engages projections 240 located in the offset section 140 to maintain the lever 110 in the closed position. A cam 246 is provided centrally on the edge portion 222 of the lever 110. The cam 246 is configured to engage the post 184 on the lever member 170.

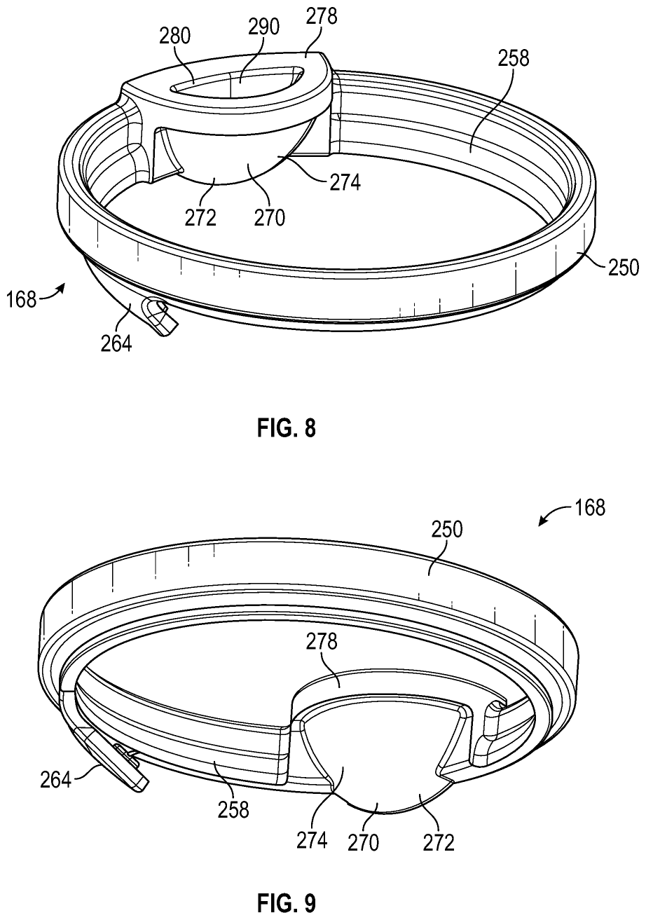

As indicated, the container seal or gasket 168 is secured within the cavity 160 of the lid body 102 and is sized to aid in sealing the lid 100 to the associated container. With reference to FIGS. 2, 8 and 9, the container seal 168 includes a sealing body 250 being annular in shape to correspond to the shape of the lid body 102. The sealing body 250 is mounted to the lid body 102 between the sidewall 104 of the outer body 120 and a mounting flange 252 provided on the inner body 122 (FIGS. 5, 6 and 10). In the depicted aspect, the sealing body 250 includes an inner annular stepped section 258 that is fitted onto a correspondingly outer stepped section 260 on the mounting flange 252. A gripping tab 264 can depend from the sealing body 250 to allow for easy removal of the container seal 168 from within the cavity 160 of the lid body 102. According to the present disclosure, the container seal 168 is configured to move the lever member 170 from the unsealed position back toward the sealed position with respect to the drinking opening 108 when a rotational force is removed from the lever member. The container seal 168 is further configured to maintain the lever member 170 in the sealed position.

More specifically, the container seal 168 includes a biasing element 270 configured to engage the body 172 of the lever member 170. The biasing element 270 is secured to the sealing body 250 and extends inwardly from the sealing body so as to not interfere with the container seal sealing of the lid 100 to the associated container. In the depicted aspect, the biasing element is integral with the sealing body 250 so as to define a unitary, one-piece seal component of the lid 100. The biasing element 270 can be in the form of a bulbous member 272 that is budged inwardly from the seal body 250 and having an outer surface 274 coved or swept upwardly. The bulbous member 272 can be sized greater than a height dimension of the seal body 250 such that the bulbous member extends slightly below the seal body. Further, to allow for the biasing of the lever member 170, the bulbous member 272 is substantially hollow so that the lever member 170 compresses the bulbous member as the lever member is moved toward the unsealed position. This compression of the bulbous member 272 creates a spring biasing force sufficient to move the lever member 170 back toward the sealed position. Further, in the sealed position of FIG. 10, the bulbous member 272 remains slightly compressed by the lever member 170, creating a spring biasing force sufficient to maintain the lever member in the sealed position.

A frame structure 278 can substantially surround the bulbous member to provide strength to that section of the seal body 250 having the bulbous member. The frame structure 278 can additional frame an opening 280 into an interior 290 of the bulbous member 272. In the depicted embodiment of FIG. 5, to ensure proper positioning and mounting of the container seal 168 to the lid body 102, the stepped section 260 on the mounting flange 252 includes a cutout 282 sized to receive the bulbous member 272. Further, the bottom wall 162 of the inner body 122 includes a platform 284 located within this cutout 282 and shaped and sized to be at least partially received in the opening 280. The frame structure 278 ensures a friction fit of the platform 284 within the opening 280.

FIGS. 10-13 show movement of the lever 110 from the closed position to the open position, and the resulting movement of the lever member 170 from the sealed position to the unsealed position to open the drinking opening 108. In FIG. 10, the lever 110 is in the closed position and the lever member 170 is in the sealed position with the lever sealing member 114 sealingly engaging the sealing surface 164 of the bottom wall 162 around the drink opening 108 and the post opening 200. The post 184 of the lever member 170 is extended through the opening 200 and is offset from the cam 246. The body 172, specifically the attachment element 188, abuts the biasing element 270 (i.e., bulbous member 272). The biasing element 270 is at least partially compressed by the lever member 170. Because the post 184 is disengaged from the cam 246, an entirety of the biasing force of the biasing element 270 is directed toward maintaining the lever sealing member 114 in contact with the sealing surface 164. This, in turn, maintains the lever member 170 in the sealed position. In FIG. 11, the lever 110 is rotated about the rotational axis 112 upwardly relative to the lid body 102. The cam 246 presses the post 184 slightly downward in the opening 200 causing the lever member 170 to rotate about the rotational axis 198 and the sealing member 114 to disengage from the sealing surface 164 opening the drink opening 108. The attachment element 188 of the body 172 slightly compresses the bulbous member 272.

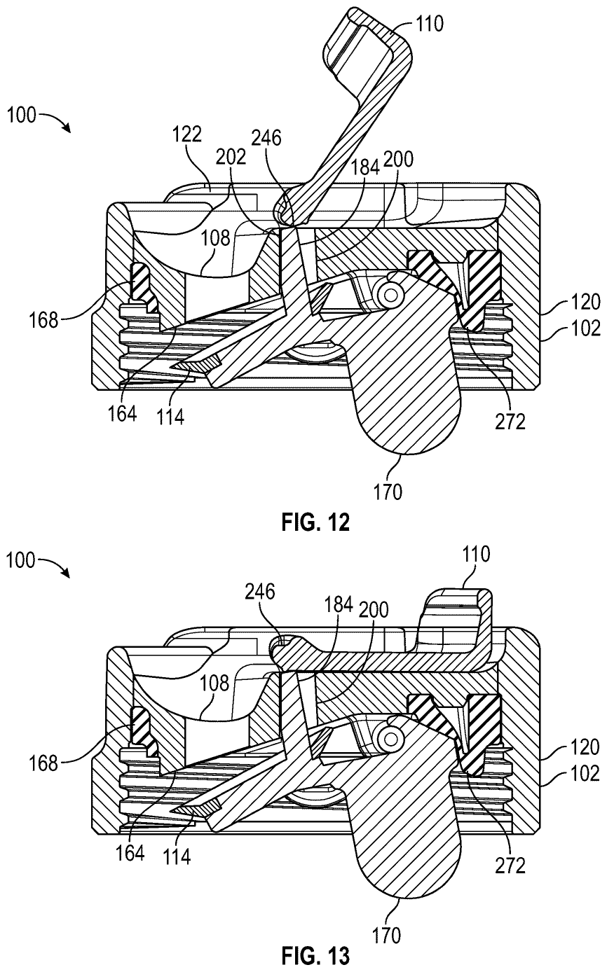

In FIG. 12, the lever 110 is further rotated causing the cam 246 to move the face 202 of the post 184 toward an inner surface of the opening 200. The lever member 170 is in the unsealed position and the drink opening 108 is fully open. The bulbous member 272 is further compressed by the body 172. In FIG. 13, the lever 110 is in the open position, and the lever member 170 is maintained in the unsealed position. It should be appreciated that with the lever 110 in the open position, the post 184 is in contact with a surface of the lever 110. This prevents the biasing element 270 from returning the lever 110 back toward the closed position, allowing the lever 110 to stay in the open position. However, movement of the lever 110 back toward the closed position reengages the cam 246 with the post 184 (FIG. 12). Therefore, should a user release the lever in the position of FIG. 12, the spring force of the compressed biasing element (i.e., bulbous member 272) will bias the lever 110 back toward the closed position of FIG. 10, and, in turn, will rotate the lever member 170 back toward the sealed position of FIG. 10 to close the drink opening 108. As indicated, because the biasing element 270 is still slightly compressed in the position of FIG. 10, the biasing element 270 maintains the lever member 170 in the sealed position, and, in turn, the lever 110 in the closed position.

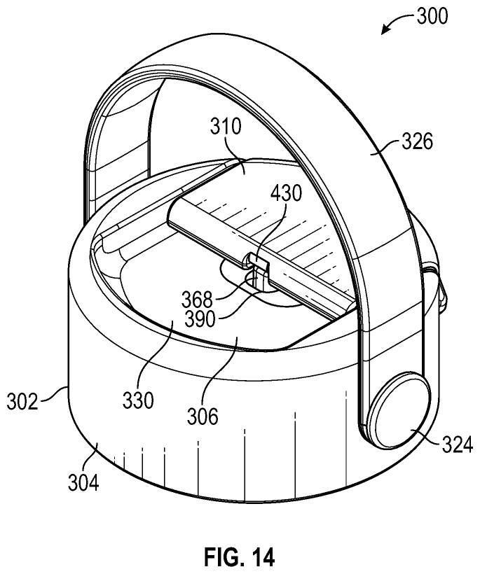

FIG. 14 illustrates an exemplary lid 300 according to another aspect the present disclosure which is complementary to an associated beverage or fluid container (not shown). The lid 300 includes a substantially cylindrical shaped lid body 302 having a sidewall 304 and a top wall 306. The top wall 306 is provided with a cutout 308. A lever or flip 310 is connected to the lid body 302 and is movable between a closed position and an open position relative to the lid body 302 to selectively seal and unseal a lever sealing member 314 to close and open, respectively, a drinking opening 318. The lever sealing member 314 and drinking opening 318 are provided a removable insert of puck 320. Strap connectors or lugs 324 extend outwardly from the sidewall 304 to allow a strap 326 to connect with the lid 300. The lid body 302 defines an elongated recessed portion 330 for the lever 310 that extends between a forward end 332 adjacent the cutout 308 and a rearward end 334 along the top wall 306. The recessed portion 330 terminates at a drinking lip 338 at the forward end, which is formed by an offset section 340 in the sidewall 304.

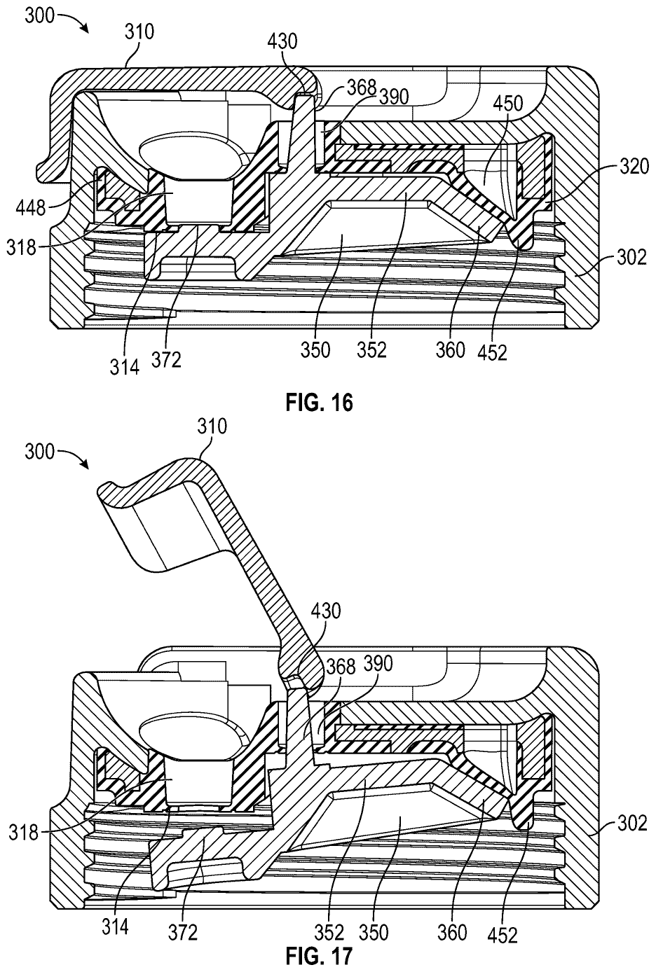

A lever member 350 is connected to the lid body 302. The lever member 350 has a body 352 with a first end portion 358 and a second end portion 360 opposite the first end portion relative to a length direction of the body 302. The first end portion is inclined downward to correspond to the arrangement of the lever sealing member 314 and drinking opening 318 on the insert 320. A platform 366 is provided on the first end portion 358 and a piston or post 368 is located on the body 352 adjacent the platform 366. The platform 366 includes a raised portion 372 sized to be received in the drinking opening 318, and when located in the drink opening 318 the lever sealing member sealingly engages an outer perimeter of the raised portion 372 which, in turn, seals off and closes the drinking opening 318. An attachment element 378 is located at the second end portion 360, the attachment element defined by pivot pins 382 extended laterally outward from the body 352. The pivot pins are received in openings provided on a lower surface of the insert 320 allowing the lever member 350 to rotate about a rotational axis defined by the pins 382 between sealed and unsealed positions with respect to the drinking opening 318 when a rotational force is applied to the lever member 350 by a user rotating the lever 310. With the lever member 350 connected to the insert 320, the post 368 projects through an opening 390 (FIG. 16) in the insert 320 for engagement with the lever 310. The opening 390 is sized to allow the post 368 to move or pivot therein as the lever member 350 is moved between the sealed and unsealed positions. The post 184 can include a substantially planar face 392 which severs as a rotational stop for the lever member 350.

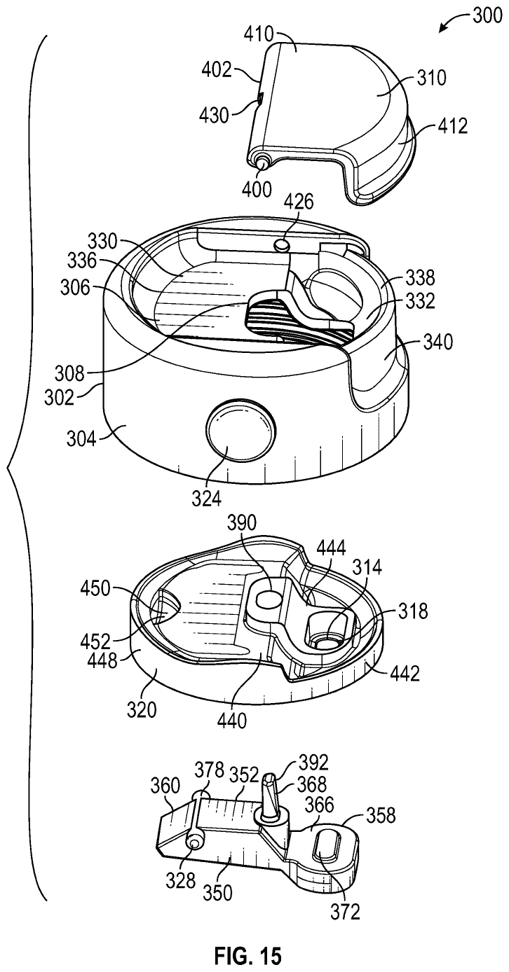

With reference to FIG. 15, the lever 310 is connected to the lid body 302 via two pivot pins 400 extended laterally outward from an edge portion 402 of the lever. The pivot pins 400 are rotatably received in apertures 426 in the lid body 302. The lever 310 includes an upper surface 410 and a side surface 412. In the closed position of the lever 310, the upper surface 410 covers the forward end 332 of the recessed portion 330 including the drinking opening 318 and the side surface 412 is provided over the drinking lip 338 and is received in the offset section 340 of the sidewall 104. Further, in the closed position, the side surface 412 is substantially a continuation of the sidewall 304 to substantially maintain a constant diameter of the lid body along a height dimension of the lid body. A cam 430 is provided centrally on the edge portion 402 of the lever 310. The cam 430 is configured to engage the post 368 on the lever member.

According to the present disclosure, the insert 320 is defined by a core 440 and an elastic member 442 secured by (i.e., overmolded onto) the core 440. The elastic member 442 defines a raised platform 444 having the lever sealing member 314 surrounding the drinking opening 318 and the post opening 390. The raised platform is sized to be received in the cutout 308 in the lid body 302. The elastic member 442 further defines a container seal or gasket 448 being annular in shape to correspond to the shape of the lid body 102, the gasket 448 sized to aid in sealing the lid 300 to the associated container. According to the present disclosure, the elastic member 442 is configured to move the lever member 350 from the unsealed position back toward the sealed position with respect to the drinking opening 318 when a rotational force is removed from the lever member. The elastic member 442 is further configured to maintain the lever member 350 in the sealed position.

More specifically, the elastic member 442 includes a biasing element 450 configured to engage the body 352 of the lever member 350. The biasing element can be in the form of a bulbous member 452 that is budged inwardly and having an outer surface coved or swept upwardly. Further, to allow for the biasing of the lever member 350, the bulbous member 452 is substantially hollow so that the lever member 350 compresses the bulbous member as the lever member is moved toward the unsealed position. This compression of the bulbous member 452 creates a spring biasing force sufficient to move the lever member 350 back toward the sealed position. Further, in the sealed position of FIG. 16, the bulbous member 452 remains slightly compressed by the lever member 350, creating a spring biasing force sufficient to maintain the lever member in the sealed position.

FIGS. 16-19 show movement of the lever 310 from the closed position to the open position, and the resulting movement of the lever member 350 from the sealed position to the unsealed position to open the drinking opening 318. In FIG. 16, the lever 310 is in the closed position and the lever member 350 is in the sealed position with the lever sealing member 314 sealingly engaging the raised portion 372 located in the drinking opening 318. The post 368 is in the post opening 390. The post 368 of the lever member 350 is extended through the opening 390 and is engaged by the cam 430 of the lever 310. The body 352, specifically the second end portion 360, abuts the biasing element 450 (i.e., bulbous member 452). The biasing element 450 is at least partially compressed by the lever member 350 thereby maintaining the lever member 350 in the sealed position. In FIG. 17, the lever 310 is rotated upwardly relative to the lid body 302. The cam 430 presses the post 368 slightly downward in the opening 390 causing the lever member 350 to rotate the raised portion 372 away from the drinking opening 318. The second end portion 360 of the body 352 slightly compresses the bulbous member 452.

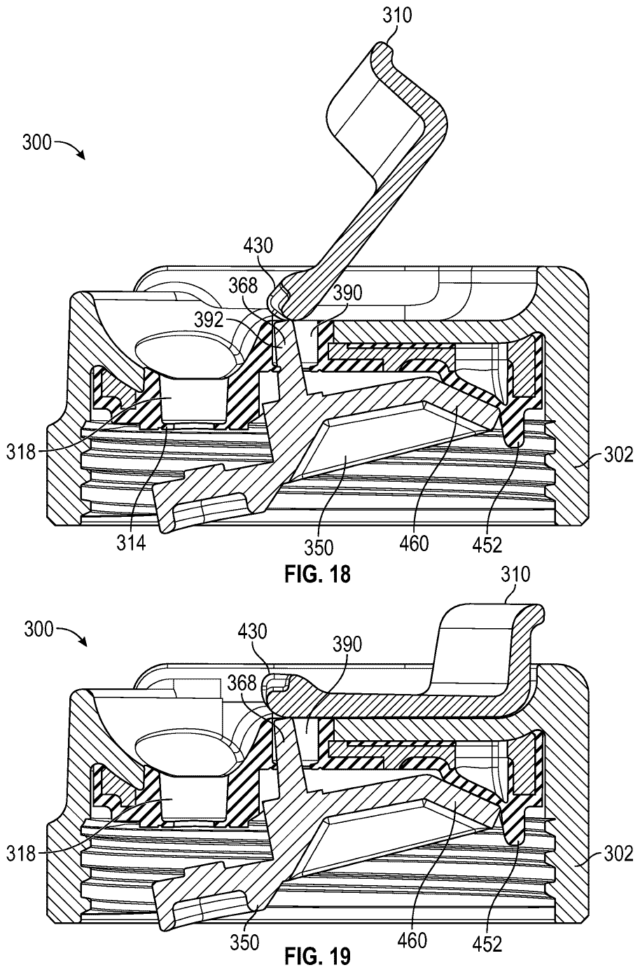

In FIG. 18, the lever 310 is further rotated causing the cam 430 to further move the post 368 in the opening 390. The lever member 350 is in the unsealed position and the drink opening 318 is fully open. The bulbous member 452 is further compressed by the second end portion 360. In FIG. 19, the lever 310 is in the open position, and the lever member 350 is maintained in the unsealed position. It should be appreciated that with the lever 310 in the open position, the post 368 is in contact with a surface of the lever 310. This prevents the biasing element 450 from returning the lever 310 back toward the closed position, allowing the lever 310 to stay in the open position. However, movement of the lever 310 back toward the closed position reengages the cam 430 with the post 368 (FIG. 18). Therefore, should a user release the lever in the position of FIG. 18, the spring force of the compressed biasing element (i.e., bulbous member 452) will bias the lever 310 back toward the closed position of FIG. 16, and, in turn, will rotate the lever member 350 back toward the sealed position of FIG. 16 to close the drink opening 318. Because the biasing element 450 is still slightly compressed in the positions of FIG. 16, the biasing element 450 maintains the lever member 350 in the sealed position, and, in turn, the lever 310 in the closed position.

It will be appreciated that various presently unforeseen or unanticipated alternatives, modifications, variations or improvements therein may be subsequently made by those skilled in the art which are also intended to be encompassed by the present disclosure and the preceding claims.

1. A lid for a beverage container comprising:
a lid body and a drink opening;
a lever connected to and above the lid body and movable between a closed position for covering the drink opening and an open position;
a lever member connected to and beneath the lid body and movable between a sealed position for sealingly closing the drink opening and an unsealed position for opening the drink opening; and
a container seal provided within the lid body for sealingly engaging the container, the container seal including a biasing element in contact with the lever member, wherein the biasing element is configured to maintain the lever member in the sealed position and is configured to move the lever member from the unsealed position back toward the sealed position with respect to the drinking opening.

2. The lid of claim 1, wherein the biasing element is configured to maintain the lever in the closed position, and with the lever moved away from the closed position the biasing element is configured to move the lever back toward the closed position with respect to the drinking opening.

3. The lid of claim 2, wherein a cam is provided on the lever, the cam is configured to engage the lever member as the lever is moved between the closed position where the lever member is in the sealed position and the open position where the lever member is in the unsealed position.

4. The lid of claim 3, wherein the lid body includes an opening, the lever includes a post extended through the opening for engagement with the cam, the opening is sized to allow the post to move or pivot therein as the lever member is moved between the sealed position and the unsealed position.

5. The lid of claim 3, wherein the biasing element is configured so that the lever member in the sealed position compresses the biasing element, the compression of the biasing element creating a spring biasing force, wherein with the lever in the closed position, the cam is disengaged from the lever member, and an entirety of the spring biasing force of the biasing element is directed toward maintaining the lever member in the sealed position.

6. The lid of claim 1, wherein a lever sealing member is provided on the lever member, wherein movement of the lever member selectively seals and unseals the lever sealing member to close and open, respectively, the drink opening.

7. The lid of claim 1, wherein the container seal includes a sealing body complementary in shape to a shape of the lid body, and the sealing body is mounted to the lid body.

8. The lid of claim 7, wherein the biasing element is secured to the sealing body and extends inwardly from the sealing body so as to not interfere with the sealingly engagement of the container seal to the container.

9. The lid of claim 7, wherein the biasing element is integral with the sealing body so as to define a unitary, one-piece seal component of the lid.

10. The lid of claim 7, wherein the biasing element is in the form of a bulbous member that is bulged inwardly from the sealing body.

11. The lid of claim 1, wherein the biasing element is configured so that the lever member compresses the biasing element as the lever member is moved toward the unsealed position, the compression of the biasing element creating a spring biasing force sufficient to move the lever member back toward the sealed position.

12. The lid of claim 1, wherein the biasing element is configured so that the lever member in the sealed position compresses the biasing element, the compression of the biasing element creating a spring biasing force sufficient to maintain the lever member in the sealed position.

13. A seal to be provided in a lid body of a lid for sealingly engaging an inner surface of a beverage container, the seal comprising:
a sealilng body to be positioned between the lid body and the inner surface of the container; and
a biasing element secured to the sealing body and extended inwardly from the sealing body so as to not interfere with the sealingly engagement of the sealing body to the inner wall of the container.

14. The seal of claim 13, wherein the biasing element is integral with the sealing body so as to define a unitary, one-piece seal component.

15. The seal of claim 13, wherein the biasing element is adapted to compress to create spring biasing force.

16. The seal of claim 15 in combination with the lid for the beverage container, the lid comprising:
the lid body and a drink opening;
a lever connected to and above the lid body and movable between a closed position for covering the drink opening and an open position;
a lever member connected to and beneath the lid body and movable between a sealed position for sealingly closing the drink opening and an unsealed position for opening the drink opening; and
the seal provided within the lid body and the biasing element in contact with the lever member,
wherein with the lever moved away from the closed position the biasing element is configured to move the lever back toward the closed position with respect to the drinking opening,
wherein the biasing element is configured to maintain the lever member in the sealed position and is configured to move the lever member from the unsealed position back toward the sealed position with respect to the drinking opening.

17. The combination of claim 16, wherein the biasing element is configured so that the lever member compresses the biasing element as the lever member is moved toward the unsealed position, the compression of the biasing element creating a spring biasing force sufficient to move the lever member back toward the sealed position, and
wherein the biasing element is configured so that the lever member in the sealed position compresses the biasing element, the compression of the biasing element creating a spring biasing force sufficient to maintain the lever member in the sealed position.

18. The combination of claim 17, wherein with the lever in the closed position, the lever is disengaged from the lever member, and an entirety of the spring biasing force of the biasing element is directed toward maintaining the lever member in the sealed position.
